(19) United States
(12) Patent Application Publication
(10) Pub. No.: US 2005/0275244 A1
(43) Pub. Date: Dec. 15, 2005

(54) Motor barber shop, motor beauty shop, motor nail shop on wheels

(76) Inventor: Markel Henry LeBlanc, Iowa, LA (US)

Correspondence Address: Markel Henry LeBlanc, P.O. Box 129, Iowa, LA, 70647, US

(21) Appl. No.: 10/999,616

(22) Filed: Jan. 26, 2005

Related U.S. Application Data
(60) Provisional application No. 60/578,359, filed on Jun. 10, 2004.

(51) Int. Cl. B60P 1/00

(52) U.S. Cl. 296/156

(57) ABSTRACT

A Motor Home Unit was reconstructed into a Barber and Cosmetology shop, designed to extend special accomodations to the public. This was designed for after normal business hours for the public who cannot make it to a local barber shop. The main objective is to provide professional and timely services to enhance the outward appearance of the public. The idea of the Motor Barber and Cosmetology Shop is to extend special services after business hours at a convenient time to the public at their residences or businesses. The same professional services provided during business hours will as well be provided after business hours to the public. Products are carefully chosen for the public to choose for purchase and /or use in the shop. Handicap availability is inclusive for the disabled, those confined to home and those who are hospitalized The clothing line will consist of Polo shirts, T-Shirts, headbands, Jerseys and socks, that will bear the patent logo.

The Motor Unit (Winnebago) will include a Barber chair, a beauty and nail station. The chair is mounted to the floor of the Unit. The beauty and nail station will include a manicure table, pedicure foot tub attached to the chair. The Motor Unit has a sink (Shampoo bowl) a bathroom that include a toilet and washbowl with hot and cold water for public use. A ramp win be available for handicapped customer Modern day air-compressor will be used to blow hair from customers clothing and head. An entertainment center consisting of a television, video games (PS2, X-Box), radio and DVD player.

Air conditioning and heating are for the comfort of the public in all types of weather. The floor tiles are black and white squares with red trimmings to provide an attractive interior. The outside appearance consist of: DPS-Vinyl-Color (Premium, 2 sided), Digital Printed Window Perforation Vinyl, and a Design Customer Artwork color design. Electricity will be supplied by a 1500 hp Generator attached to the Motor Unit on a platform extended in the back.

I, Markel Henry LeBlanc have invented a new design of a Motor Barber/Cosmetology shop on wheels and Barber Clothing Line as set forth in the following specification:

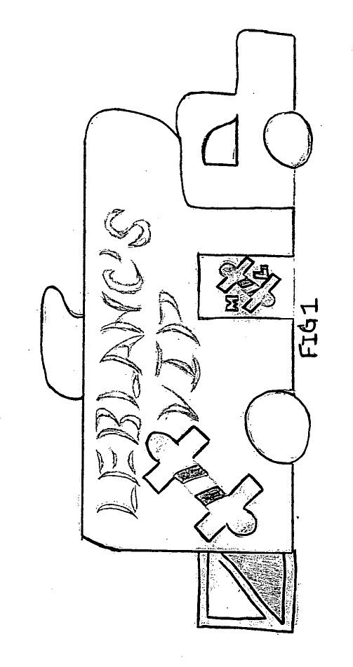

FIG. 1 is a Motor Unit original drawing of the Outside view of the Motor Barber/Cosmetology Shop.

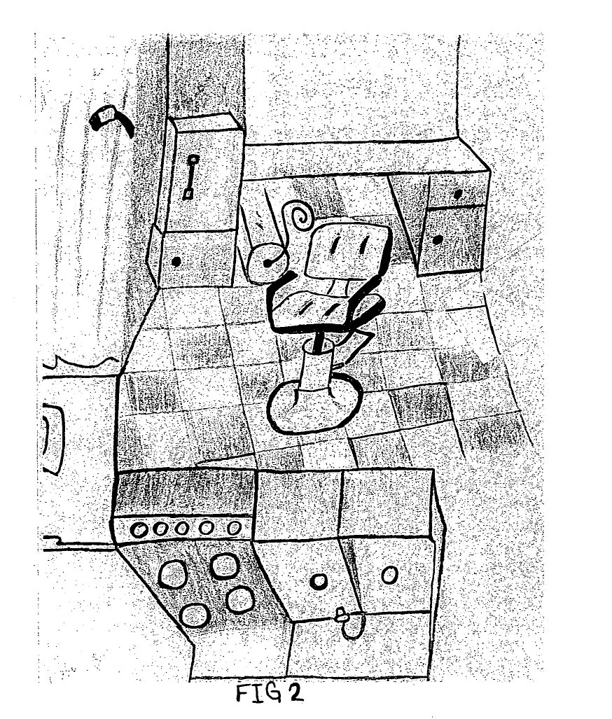

FIG. 2 is an Inside view of the Motor Unit and set up of Barber/Cosmetology shop.

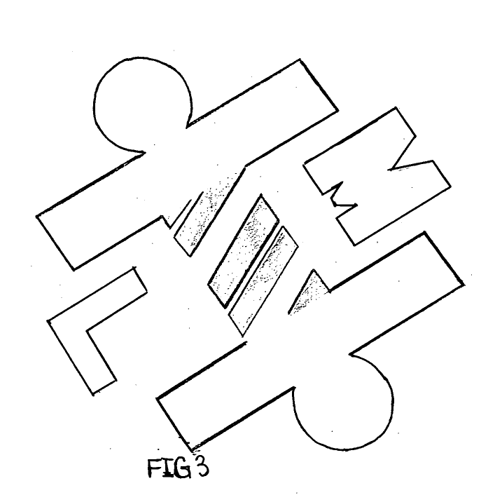

FIG. 3 is an exploded view of the trademark (MHL);

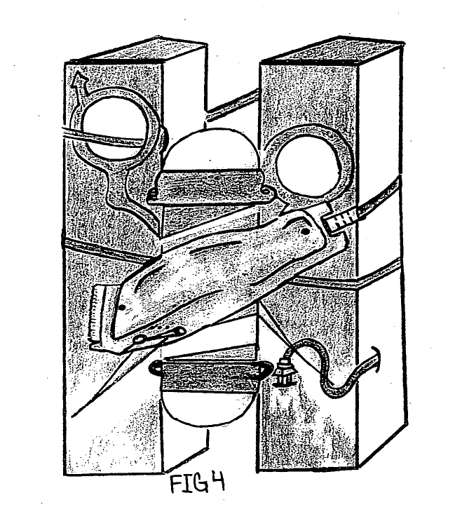

FIG. 4 is the letters (MHL) visualized with the formation consisting of Clippers, Barber Pole, Scissors and outer posts.

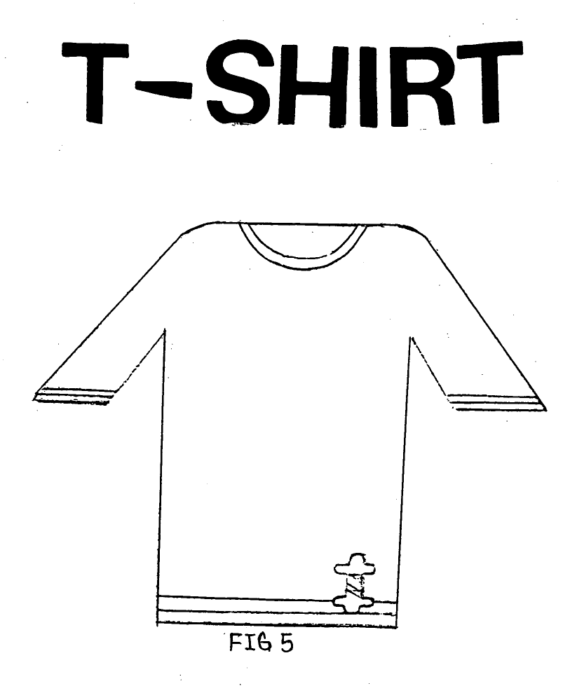

FIG. 5 is view displaying the trademark emblem in the lower left corner of the Custom Design ‘T-Shirt’

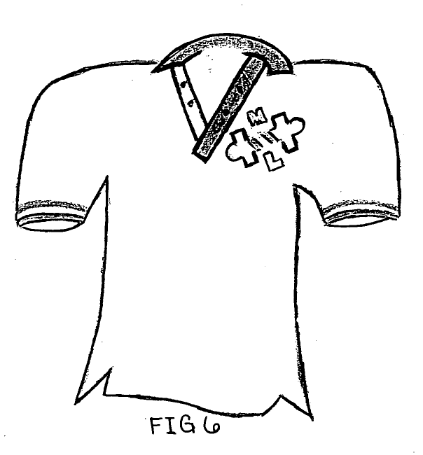

FIG. 6 is view displaying the emblem in the upper left corner of the Custom Design Polo Shirt.

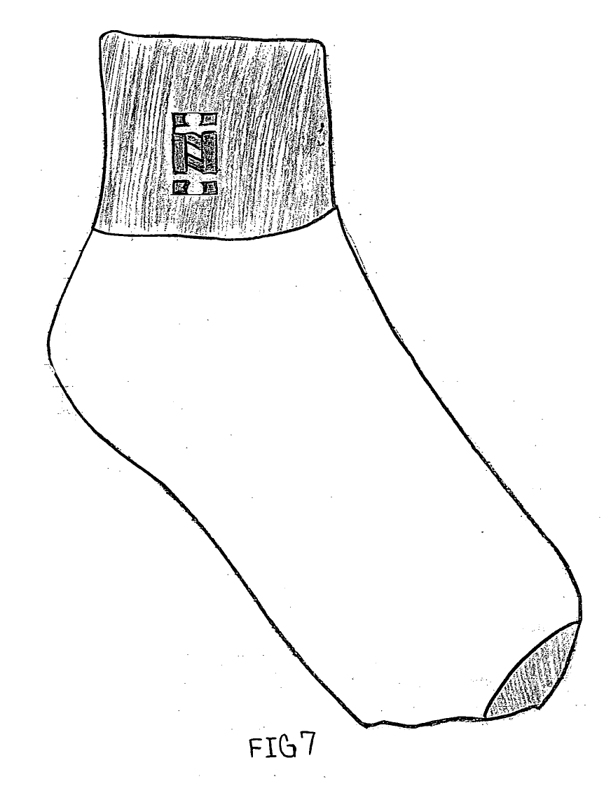

FIG. 7 is view of the trademark emblem on the top portion of the Custom Design Sock

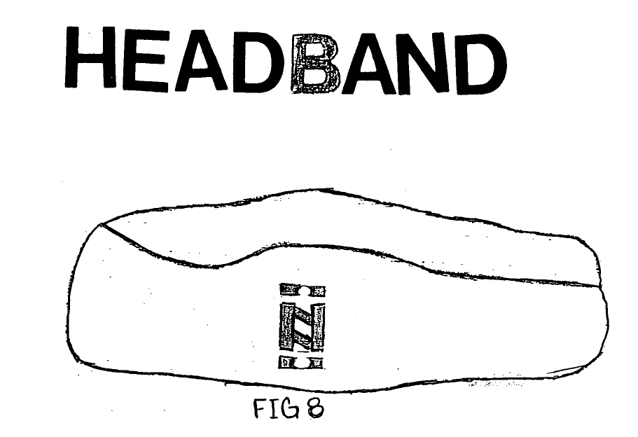

FIG. 8 is view of the trademark emblem displayed in the center of the Custom Design head-band.

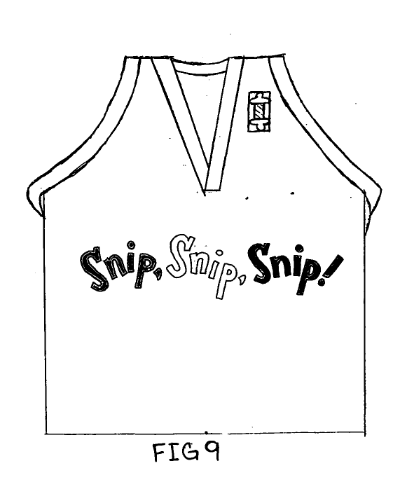

FIG. 9 is view of the trademark emblem displayed in the upper left corner of the Custom Design Jersey.

1. What I claim as my invention is, “A Motor Barber Shop on Wheels”.

2. What I claim as my invention is, “A Motor Beauty Shop on Wheels”.

3. What I claim as my invention is, “A Motor Nail Shop On Wheels”.

4. What I claim as my invention is, “A Barber and Beauty Clothing Line”, with my personal logo.
